(19) United States
(12) Patent Application Publication
(10) Pub. No.: US 2012/0021384 A1
(43) Pub. Date: Jan. 26, 2012

(54) CHARACTERIZATION OF AN ANTIBIOTIC IMREGNATED DELIVERY SYSTEMS AS AN INTRACANAL MEDICAMENT IN ENDODONTIC THERAPY

(76) Inventors: Philip P. Stashenko, Medfield, MA (US); Douglas A. Bakan, San Diego, CA (US); Derek Kelaita, San Diego, CA (US); Robert Bruce Rutherford, Seattle, WA (US)

(21) Appl. No.: 13/157,395

(22) Filed: Jun. 10, 2011

Related U.S. Application Data
(63) Continuation of application No. PCT/US2009/067805, filed on Dec. 14, 2009.
(60) Provisional application No. 61/122,193, filed on Dec. 12, 2008.

(51) Int. Cl. A61C 5/02

(52) U.S. Cl. 433/224

(57) ABSTRACT

Endodontic fibers comprising a biocompatible polymer vehicle permeable to medicaments, or combinations of medicaments, wherein the biocompatible polymer vehicle comprises one or more biocompatible and/or biodegradable polymers are described. Such fibers can be used, for example, in a method for the local delivery and sustained release of medicaments to periodontal or intracanal treatment sites. Endodontic fibers described include periodontal fibers and intracanal fibers.

### RELATED APPLICATIONS

This application is a continuation of PCT Patent Application PCT/US2009/067805, filed Dec. 14, 2009, which claims the benefit of U.S. Provisional Application No. 61/122,193, filed Dec. 12, 2008. The entire teachings of the above-referenced applications are incorporated herein by reference.

### BACKGROUND OF THE INVENTION

Endodontics is a field of dentistry concerned with the biology and pathology of the dental pulp and periapical tissues. Endodontic treatment employs a set of techniques, such as chemomechanical debridement, irrigation, drainage of hard and soft tissue, trephination, and antimicrobial therapy, with the goal of avoiding the extraction of a damaged, infected or diseased tooth.

Normal vital pulp is sterile, and the role of bacterial infection in the pathogenesis of pulpal and periapical disease is well established. Infected or necrotic pulpal tissue renders the pulp chamber and root canal a potential reservoir of bacteria, and disinfection of the tooth is one of the primary justifications for the chemomechanical aspects of root canal therapy. Recent data demonstrate a high incidence of root canal failure in necrotic teeth treated in a single visit, attributed to bacteria remaining in complex anatomical spaces such as accessory canal, fins, deltas and isthmuses (Sjorgen et al., Int. Endo. J., 30:297-306 (1997)). Other studies have reported the ability of bacteria to migrate into dentinal tubules and survive therein (Nagaoka et al., J. Endodon., 21:70-73 (1995)). It is speculated that the success rate of endodontic treatment could be 26% higher if the root canal is successfully disinfected prior to the final restoration (Sjorgen et al., Int. Endo. J., 30:297-306 (1997)).

Root canal infections are characterized as polymicrobial infections which tend to be dominated by anaerobic bacteria. As a group, the common endodontic microbes associated with treatment failure include F. nucleatum, P. intermedia, P. micros, S. intermedius, P. endodontlis, P. gingivalis, P. melaminogenica, E. lentum, V. parvula, S. sanguis, P. buccae, P. oxalis, and P. acnes. (Haapasalo, FEMS Immunol. And Medical Micro. 6:213-217 (1993) and Sundqvist, J. Endodon., 7:257-262 (1992)).

Post-operative periapical pain and interappointment flare-ups are also routinely attributed to the presence of bacteria, and/or their by-products, within the root canal. Typically, an initial bacteria infection triggers a host-mediated inflammatory response, the consequences of which underlie the flare-up patient's clinical symptoms. It has been reported that bacteria surviving instrumentation and irrigation proliferate rapidly in empty root canals (Bystrom and Sundqvist, Oral. Surg. Oral. Med. Oral Pathol., 55:307-312 (1983)), and there is a positive correlation between the number of bacteria present in a root canal and the incidence of inter-appointment flare-ups. The presence of black-pigmented, gram negative anaerobes in the root canal usually accompanies patient complaints of pain, swelling, and tenderness to percussion (Haapasalo, FEMS Immunol. and Medical Micro., 6:213-217 (1993)). Thus, the successful elimination of bacteria from root canals may lower the incidence of flare-ups.

Antibiotics have historically been used as an adjunct to endodontic treatment either by systemic or local administration. Currently, antibiotic treatment for root canal infections and exacerbations is limited to systemic administration. Thus, in light of the established correlations between the primary and secondary effects of bacterial presence and the incidence of both interappointment flare-ups and treatment failure, there is a clear need for an efficacious method of delivering and sustaining substantial concentrations of intracanal medicaments, particularly antibiotics.

During the 1950's a polyantibiotic paste (PBSC) was devised for use as an intracanal medicament (Grossman, L. I., J. Amer. Dent. Assoc., 43:265-278 (1951)). PBSC consisted of penicillin to target gram positive organisms, bacitracin for penicillin-resistant strains, streptomycin for gram negative organisms and caprylate sodium to target yeast, all suspended in a silicone vehicle. Although clinical evaluation suggested that polyantibiotic paste conferred a therapeutic benefit (fewer treatments to achieve a negative culture), the composition was ineffective against anaerobic species (which are now appreciated as the dominant species responsible for treatment failure). In 1975 the Food and Drug Administration (FDA) banned PBSC for endodontic use primarily because of the risks of sensitization and allergic reactions attributed to the penicillin.

This underscores the importance of improving historical endodontic methodologies, particularly local delivery methods, in light of contemporary knowledge and technological advances.

### SUMMARY OF THE INVENTION

The invention relates to endodontic fibers comprising a biocompatible polymer delivery vehicle which is permeable to medicaments, or combinations of medicaments, dispersed therein. Such fibers can be used, for example, in a method for the local delivery and sustained release of medicaments to intracanal treatment sites. Endodontic fibers of this invention include periodontal and intracanal fibers.

One embodiment of the invention relates to an endodontic fiber, referred to herein as an “intracanal fiber,” which can be specifically designed for use in intracanal delivery methods, thereby obviating the need to modify a periodontal fiber for use in intracanal sites.

The intracanal fiber can be formulated to have a polymeric composition, surface tackiness, stiffness, glass transition temperature, length, and/or diameter selected to confer characteristics compatible with placement within the root canal. In a preferred embodiment, the endodontic fiber has a rigidity similar to traditional gutta percha points. Although the intracanal fiber is particularly adapted for intracanal use, other (i.e., non-intracanal) uses of this fiber are also envisioned. For example, the intracanal fiber can also be used for periodontal treatment.

In addition, the choice of medicament and the concentration at which it is incorporated into the disclosed endodontic fibers (e.g., periodontal fibers or intracanal fibers) are optimized to produce a fiber that is most likely to achieve the desired therapeutic effect. The intracanal fibers exemplified and contemplated herein are ideally suited for the local delivery and sustained release of intracanal medicaments and thus enable numerous intracanal delivery methods.

In one aspect of endodontic use, endodontic fibers (e.g., periodontal fibers or intracanal fibers) are utilized for the intracanal delivery and sustained release of antibiotics predicted to be efficacious for the treatment of an established endodontic bacterial infection. The goal of the intracanal delivery of antibiotics in this context is to achieve a sufficient drug concentration and duration of exposure, to effect inhibition (e.g., partial or complete inhibition) of all bacterial growth within the pulp chamber and root canal, thereby obviating the need for systemic antibiotic administration. Ultimately, the ability to successfully treat established bacterial infections will reduce endodontic treatment failures and improve the long-term outcome of the procedures.

In an alternative embodiment, an intracanal delivery method using endodontic fibers of the invention is utilized prophylactically to disinfect a root canal receiving endodontic treatment prior to the application of a final restoration. In this context, the local delivery method is employed to eradicate any residual bacteria which were not removed by the chemomechanical preparation of the canal. More specifically, the purpose of this method of delivery is to suppress bacterial growth, particularly the proliferation of black-pigmented, gram negative organisms, within the root canal. Such prophylaxis can reduce the level of patient pain due to inflammation, reduce elicited pain such as due to biting, reduce patient sensitivity to stimuli such as pressure in and surrounding the root of the tooth, and reduce the occurrence of interappointment flare-ups, and ultimately minimize the risk of treatment failures.

In an alternative embodiment, an intercanal delivery method using endodontic fibers of the invention seals the root canal to hinder the communication of its interior with periapical tissues. In this context, the endodontic fiber acts as a sealant to prohibit periapical extrudate from leaking into the canal. This reduction in apical leakage may improve the healing process.

In an alternative embodiment, an intracanal delivery method using endodontic fibers of the invention is suitable for the sustained release of agents capable of causing a chemical reaction producing antimicrobial activity.

In other embodiments of the invention, endodontic fibers described herein can be used to deliver alternative intracanal medicaments necessitated by a course of endodontic treatment. For example, in an effort to attenuate a host-mediated inflammatory response resulting from the presence of bacterial by-products in periapical tissues, an anti-inflammatory agent, either alone or in combination with an antibiotic, can be incorporated into the endodontic fiber.

### DETAILED DESCRIPTION OF THE INVENTION

The role of endogenous microflora as a source of bacterial infection contributing to endodontic treatment failure is well established (Kakehashi, S. et al., Oral Surg., 20:340-348 (1965)). The bacterial species most often associated with infections of endodontic origin belong to the genera Prevotella, Porphyromonas, Fusobacterium, Peptostreptococcus, Eubacterium and Streptococcus. Some published studies have implicated species of black-pigmented, gram negative anaerobes as possible endopathogens (based on a frequency of isolation in the 25% to 50% range from teeth experiencing treatment failure), however, no single species has been proven to be more pathogenic than others (USAIDR Information Bulletin, 4(3) (1990)).

A “flare-up” is defined as pain and/or swelling which occurs within a few hours to a few days after a root canal treatment procedure. Depending upon the severity of the symptoms, there is often a sufficient disruption of the patient's lifestyle such that the patient initiates an unscheduled visit and treatment. Published studies suggest that the presence of members of the black-pigmented Porphyromonas (particularly Porphyromonas gingivalis and Porphyromonas endodontalis) within the root canal correlate with the type of acute symptoms responsible for inter-appointment flare-ups (Yoshida et al., J. Endodon., 13:24-28 (1987)). Thus, in addition to reducing the failure rate of endodontic treatment, it also desirable to reduce the frequency of interappointment flare-ups. Additionally, while the incidence of flare-ups are decreasing, it is desirable to reduce patient sensitivity to stimuli such as pressure in and surrounding the root of the tooth.

The term “about,” as used herein, includes the recited number ±10%. Thus, “about ten” means 9 to 11.

Antibiotics have historically been used as an adjunct to endodontic treatment, either by systemic or local administration. Currently, antibiotic treatment for root canal infections and exacerbations is limited to systemic administration. Commonly prescribed antibiotics include penicillins (e.g., penicillin V, amoxicillin), erythromycins (e.g., erythromycin stearate), lincosamides (e.g., clindamycin) and cephalosporins (e.g. cephalexin). The decision to use antibiotics is often made by the practitioner in relation to his or her own treatment philosophy. The choice is made in light of the knowledge that systemic antibiotics should be prescribed with restraint because of the possibilities of hypersensitivity or anaphylactic reactions, toxicity, adverse systemic effects, and the development of resistant strains of microorganisms.

A critical reevaluation of the merits of delivery devices, vehicles, techniques, and medicaments which have been historically utilized for intracanal delivery methods reveals that the use of intracanal medicaments in general, and in particular the use of intracanal antibiotics, has been criticized for inadequate spectrum of activity and short duration of effectiveness. The former issue has been addressed by improved microbiological sampling techniques, particularly anaerobic culturing techniques, which now provide practitioners with an accurate profile of the bacterial species associated with endodontic infections. This information enables practitioners to prescribe more appropriate antimicrobial agents. As a result, the short duration of effectiveness has emerged as the major flaw of intracanal delivery protocols. The endodontic fibers described herein address this issue by allowing a treatment strategy which is demonstrated to be capable of the sustained release of active medicament over a range of durations ranging from hours to weeks (in vitro).

The disclosed endodontic fibers enable a delivery system and method capable of the sustained release of any class of medicament that is necessitated as a consequence of therapy, particularly root canal therapy. In preferred embodiments, the invention provides a therapeutic method for the treatment of an endodontic bacterial infection, or alternatively a controlled aseptic technique suitable for use as an adjunct to conventional chemomechanical debridement and irrigation techniques.

Systemic administration relies upon circulatory elements to bring active drug to an infected site. However, it is well recognized that infected and/or inflamed periradicular tissue and necrotic pulpless teeth do not posses a normal vasculature. This practical consideration renders systemic administration inefficient, particularly when it is combined with the knowledge that to be effective, an antibiotic must be in contact with the targeted microorganisms. These facts clearly compromise the potential utility of systemically administered prophylactic antibiotics for root canal therapy.

In contrast, a local delivery strategy confers the therapeutic benefit of delivering a medicament directly to the targeted tissue space. In addition, use of the disclosed delivery vehicle and method is readily amenable to both bacteriological sampling and sensitivity screening in the event that an infection does not respond to an initial course of treatment. The option of easy removal of the fiber in the case of an unforeseen complication or allergic reaction provides additional flexibility in the use of the invention. The latter feature represents a significant improvement over the historical use of paste or liquid compositions that can be difficult or impossible to remove or cease functioning.

Furthermore, the ability to establish substantial local concentrations of an antibacterial agent also minimizes the risk of contributing to the development of drug resistant pathogens. One of the major contraindications to the use of systemic antibiotics is the theoretical possibility that bacteria not affected by the relatively low concentrations achieved by oral administration will give rise to strains having multiple drug resistance. Intracanal delivery also spares the patient from unwanted side-effects commonly associated with systemic administration strategies. For example, systemic administration of clindamycin, as well as other antibiotics, has been associated with the occurrence of pseudomembranous colitis, a sufficiently deleterious side effect which accounts for the reluctance of many clinicians to prescribe clindamycin, despite its broad spectrum of activity. However, given the dosages required to cause pseudomembranous colitis, along with the requirement for gastrointestinal contact, it is highly unlikely that the intracanal use of endodontic fibers containing clindamycin would trigger such an adverse side effect. This later benefit can be decisive in terms of prescribing a particular medicament whose spectrum of activity may be well suited for the task, but whose systemic administration carries a high risk of toxicity.

The intracanal fibers described herein are specifically designed for use in intracanal delivery methods. The optimal composition of the fibers can be empirically determined to confer the physical characteristics and polymeric composition required for intracanal use. The intracanal fibers can have a diameter of from about 0.1 mm to about 2.0 mm. In one embodiment, the endodontic fiber has a diameter of from about 0.1 mm to about 0.5 mm; this particular diameter range facilitates placement deep within the cleaned and reshaped root canal. In another embodiment, the intracanal fiber has a diameter of about 0.3 mm. More specifically, the fibers may be characterized by additional features such as being odorless, being colored or colorless, permitting deep penetration of the root canal, being suitable for use with a variety of therapeutic agents, being capable of the sustained release of at least one active agent (e.g., for at least a one week period of time (in vitro)), and not staining tooth structure or interfering with standard bacterial culture techniques.

The composition and glass transition temperature of the polymer can also be selected to confer surface characteristics and a level of rigidity required to accomplish the aseptic placement of the fiber within the root canal, and to facilitate the subsequent conformity of the fiber to the contours of the root canal. Biocompatible vehicles useful for the formulation of the disclosed endodontic fibers are biocompatible synthetic or natural copolymers, which may or may not be biodegradable. For example, polymers including natural polymers, polyesters such as polyglycolides and polylactides, polylactones, poly(propylene fumarates), polyanhydrides, poly(anhydride-co-imides), hydroxybutyric acids, tyrosine-based polycarbonates, polyurethanes, methacrylate polymers, ethylene vinyl acetate polymers, ethylene vinyl alcohol copolymers, poly(p-dioxanes), polyphosphazenes, and combinations thereof are suitable for use in this invention. The form (i.e., shape) of the polymer composition is not critical as long as the form allows the composition to be positioned within the root canal, preferably the positioning required is deep within the tooth canal to enable the medicament to act locally at the site of deep bacterial infection. In one embodiment, the form of the polymer composition is a string or fiber.

The biocompatible copolymer vehicles useful for the formulation of the disclosed endodontic fibers may include mixtures of biodegradable and non-biodegradable polymers. If a biodegradable polymer is present in the endodontic fiber it may be in any percentage from about 1% to about 100%. If a biodegradable polymer is present it may be in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100%.

Biodegradable polymers useful in the invention include natural polymers, polyesters such as polyglycolides and polylactides, polylactones, poly(propylene fumarates), polyanhydrides, hydroxybutyric acids, tyrosine-based polycarbonates, polyorthoesters, polyurethanes, poly(p-dioxanes), polyphosphazenes, and combinations thereof.

Examples of natural biodegradable polymers useful in the invention include collagen, starch, cellulose, lignin, chitin, polysaccharides, and chitosan.

Examples of biodegradable polyesters useful in the invention include polyglycolides, polylactides, poly(dioxanone), poly(3-hydroxyvalerate), poly(valerolactone), poly(tartronic acid), and poly(β-malonic acid).

Examples of biodegradable polyglycolides and polylactides useful in the invention include polyglycolic acid, polylactic acid, poly(DL-lactide), poly(L-lactide), and copolymers such as poly(DL-lactide-co-caprolactone), poly(L-lactide-co-caprolactone-co-glycolide), poly[(lactide-co-ethylene glycol)-co-ethyloxyphosphate], and poly(DL-lactide-co-glycolide).

Examples of biodegradable polylactones useful in the invention include polycaprolactone, polycaprolactone diol, and polycaprolactone triol.

Examples of biodegradable polyanhydrides and poly(anhydride-co-imides) useful in the invention include poly[1,6-bis(p-carboxyphenoxy)hexane], poly[(1,6-bis(p-carboxyphenoxy)hexane)-co-sebacic acid], poly [1,4-bis(hydroxyethyl)terephthalate-alt-ethyloxyphosphate], poly[1,4 -bis(hydroxyethyl)terephthalate-alt-ethyloxyphosphate]-co-1,4-bis(hydroxyethyl)terephthalate-co-terephthalate, poly(1,4-butylene adipate-co-polycaprolactam, poly(sebacic acid), poly-[trimellitylimidoglycine-co-bis(carboxyphenoxy)hexane, and poly[pyromellitylimdoalanine-co-1,6-bis(carbophenoxy)-hexane.

Examples of biodegradable hydroxybutyric acids useful in the invention include poly[(R)-3-hydroxybutyric acid], poly[(R)-3-hydroxybutyric acid-co-(R)-3-hydroxyvaleric acid], and poly(3-hydroxybutyrate).

Examples of biodegradable polyphospazenes useful in the invention include poly(bis(4-carboxyphenoxy)phosphazene), poly(bis(4-carboxyphenoxy)phosphazene disodium salt, poly(bis(1,4-dioxapentyl)phosphazene), poly(bis(1-(ethoxycarbonyl)methylamino)phosphazene), and poly[bis(1-(ethoxycarbonyl)-2-phenylethylamino)phosphazene].

Biodegradable polymers useful in this invention also include block copolymers such as polycaprolactone-block-polytetrahydrofuran-block-polycaprolactone, poly(ethylene glycol)methyl ether-block-polylactide, poly(ethylene glycol)-block-poly(ε-caprolactone) methyl ether, poly(ethylene glycol)-block-polylactide methyl ether, poly(ethylene oxide)-block-polycaprolactone, poly(ethylene oxide)-block-polylactide, and polylactide-block-poly(ethylene glycol)-block-polylactide.

The biodegradable polymers used in this invention will have different rates of degradation. Rates of degradation are affected by factors including configurational structure, copolymer ratio, crystallinity, molecular weight, morphology, stress, amount of residual monomer, and porosity.

The biocompatible vehicles useful for the formulation of the disclosed endodontic fibers may include mixtures of biodegradable and non-biodegradable polymers. If a non-biodegradable polymer is present in the endodontic fiber it may be in any percentage from about 1% to about 100%. If a non-biodegradable polymer is present it may be in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100%.

In one embodiment, the non-biodegradable polymer is ethylene vinyl acetate (EVA). In another embodiment, the endodontic fiber contains less than about 20%, preferably less than about 15% and more preferably less than about 10% vinyl acetate. In another embodiment, the endodontic fiber contains about 9.3% vinyl acetate.

It is recognized that in the preparation of an endodontic fiber for use in an intracanal delivery method, certain inert substances may be included to further modify the delivery characteristics, or to serve as carriers of the active agent, including solvents, suspending agents, surfactants, viscosity-controlling agents, and other pharmaceutically acceptable materials which may be desirable to solubilize or stabilize the therapeutic agent (or agents) in the delivery vehicle, or to control the rate of permeation or the action of the agents after permeation.

According to the invention, the periodontal fiber or intracanal fiber is impregnated with one or more medicaments using methods known in the art. A wide variety of medicaments may be used in the invention, either alone or in combination. Therapeutic agents suitable for use in the invention include, but are not limited to: antibiotics such as clindamycin, tetracycline, neomycin, kanamycin, metronidazole, ciprofloxacin, minocycline or canamycin; antimicrobial agents such as iodine, sulfonamides, mercurials, bisbiguanidines, or phenolics; anti-inflammatory agents such as indomethacin or hydrocortisone; immune reagents such an immunoglobulins, antigen binding fragments of immunoglobulins or immunomodulatory agents such as methotrexate; or reactive oxygen species. Reactive oxygen species may cause a chemical reaction producing antimicrobial activity and include peroxide generating species (metals or other compounds), oxygen radical forming compounds (enzymes such as peroxidases), or carbon and Pt/valerium catalysts.

Additional agents that may cause a chemical reaction producing antimicrobial activity include sodium hypochlorite, calcium hydroxide, chlorhexidine gluconate, formocresol, metacresylacetate, camphorated monochlorophenol, citric acid, and ethylenediaminetetraacetic acid.

In addition, it is recognized that in certain forms of therapy, combinations of these agents in the same delivery vehicle may be utilized in order to obtain an optimal effect. Thus, for example, an antibiotic and an anti-inflammatory agent may be combined in the preparation of a single endodontic fiber, which could be used either as an adjunct or a substitute for traditional endodontic treatment protocols.

In one embodiment, the periodontal fiber or intracanal fiber is impregnated with clindamycin at a concentration of less than 2.0 mg per 10 mm of fiber. In another embodiment, the periodontal fiber or intracanal fiber is impregnated with clindamycin at a concentration of about 1.9, 1.8, 1.7, 1.6, 1.5, 1.4, 1.3, 1.2, 1.1, 1.0, 0.9, 0.8. 0.7, 0.6, 0.5, 0.4, 0.3, 0.2 or 0.1 mg per 10 mm of fiber. In another embodiment, the periodontal or intracanal fiber is impregnated with clindamycin at a concentration of about 0.1 mg to 0.5 mg per 10 mm of fiber. In another embodiment, the periodontal or intracanal fiber is impregnated with clindamycin at a concentration of about 0.3 mg per 10 mm of fiber.

The choice of medicament, and the concentration at which it is incorporated into the endodontic fiber, can be selected to produce fibers that achieve the desired therapeutic effect, in light of a particular set of factors. For example, the initial selection of an appropriate antibiotic, and the concentration at which it is incorporated into the endodontic fiber, are empirical choices guided by knowledge of the bacterial species commonly associated with treatment failure, the condition of the particular tooth receiving treatment, and the time span between scheduled appointments. Properties desirable in an ideal intracanal antibiotic or antimicrobial agent (or combination thereof) for use during root canal treatment are that the medicament be germicidal to all, or at least a large portion of, organisms present at the treatment site, rapidly effective, capable of deep penetration into the canal system, effective in the presence of organic matter, noninjurious to periapical tissues, chemically stable, odorless, tasteless, and inexpensive. Additionally, the ideal intracanal antibiotic or antimicrobial agent (or combination thereof) for use during root canal treatment should not stain the teeth, such as would occur with tetracyclines. In practice, the selection of a therapeutic agent for use in the described intracanal delivery methods will be dictated by the permeability of the delivery vehicle to the agent, the concentration at which the agent can be incorporated into the fiber, and the toxicity of the agent.

For example, clindamycin is effective against many of the bacterial taxa commonly associated with endodontic treatment, and depending on the effective concentration achieved at the site of infection it can be either a bacteriostatic or a bacteriocidal antibiotic. It is effective against: Actinomyces, Eubacterium, Fusobacterium, Propionibacterium, microareophilic Streptococci, Peplococcus, Peptostreptococcus, Veillonella, Prevotella, and Porphyromona. Also, hypersensitivity and anaphylaxis as a result of clindamycin exposure is extremely rare. For example, clindamycin/EVA intracanal fibers are active in vitro against the black-pigmented Prevotella and Porphyromonas species, which are commonly associated with the occurrence of flare-ups. Clindamycin binds exclusively to the 50s subunit of bacterial ribosomes and interferes with peptidyl transfer, which prevents elongation of peptide chains and ultimately suppresses bacterial protein synthesis. (AHFS Drug Information Reference, 388-393 (1997)). The minimum inhibitory concentration (MIC) of clindamycin for most susceptible aerobic and microaerophilic bacteria is 0.1-0.4 mg/mL, and is often observed to be much lower than the corresponding penicillin or erythromoycin MIC. Published studies indicate that over the twenty year period ending in 1986, there has been no marked change in the sensitivity of bacteria to lincomycins, and more specifically that 70% to 80% of all bacterial species isolated have remained susceptible to clindamycin. Conversely, a reduction in bacterial sensitivity, and in some instances evidence of resistance, has emerged among amoxicillin, cephalosporins, and erythromycin during the same period of time (Woods, Aust. Dent. J, 33:420-423, 505-510 (1988)).

The use of the disclosed endodontic fibers and methods during the course of endodontic treatment can readily be adapted to complement a typical endodontic treatment program. Conventional root canal therapy is performed over a series of visits, to allow sufficient time to pass from the initial pulpectomy, chemomechanical debridement, and irrigation to ensure that the pulp chamber and root canal are aseptic prior to the application of the final restoration. Therefore, the anticipated use of the medicament-impregnated fiber in the context of either a prophylactic method, or for the treatment of an established infection, could utilize a biocompatible and/or biodegradable polymer. The controlled release characteristic of the fiber, combined with the opportunity for periodic replacement, makes the method compatible with conventional endodontic treatment protocols, and increases the likelihood that the local administration will achieve its desired therapeutic effect.

The degradation of the biodegradable polymer may take place over a period of time of several days to several years. The biodegradable fiber may or may not have started degrading prior to removal from the root canal.

The periodontal fiber and intracanal fiber claimed and described herein are suitable for use in any and all of the disclosed methods of intracanal delivery, including, but not limited to, prophylactic disinfection of the root canal, treatment of a bacterial infection, attenuation of a host-mediated inflammatory response, and the sustained delivery of an appropriate intracanal medicament necessitated by endodontic treatment.

Having now fully described this invention, it will be understood by those of ordinary skill in the art that the same can be performed within a wide and equivalent range of conditions, formulation and other parameters without affecting the scope of the invention or any embodiment thereof. All patents, patent applications and publications cited herein are fully incorporated by reference herein in their entirety.

1. An endodontic fiber suitable for the local delivery and sustained release of a medicament incorporated therein to an intracanal treatment site, comprising a biocompatible copolymer vehicle having incorporated therein said medicament, wherein the biocompatible copolymer vehicle comprises one or more polymers selected from the group consisting of natural polymers, polyesters such as polyglycolides and polylactides, polylactones, poly(propylene fumarates), polyanhydrides, hydroxybutyric acids, tyrosine-based polycarbonates, polyorthoesters, polyurethanes, poly(p-dioxanes), and polyphosphazenes, and wherein said medicament is incorporated therein at a concentration of about 0.1 mg to about 0.5 mg per 10 mm of fiber.

2. The endodontic fiber of claim 1, wherein the polymer is a polyglycoside, polylactide, polylactone, or combination thereof.

3. The endodontic fiber of claim 1, wherein the biocompatible copolymer vehicle further comprises one or more non-biodegradable polymers.

4. The endodontic fiber of claim 3, wherein said one or more non-biodegradable polymers is ethylene vinyl acetate.

5. The endodontic fiber of claim 1, wherein the biocompatible copolymer vehicle further comprises less than about 20% ethylene vinyl acetate.

6. The endodontic fiber of claim 5, comprising less than about 15% ethylene vinyl acetate.

7. The endodontic fiber of claim 5, comprising less than about 10% ethylene vinyl acetate.

8. The endodontic fiber of claim 5, comprising about 9.3% ethylene vinyl acetate.

9. The endodontic fiber of claim 1, wherein the medicament is clindamycin.

10. The endodontic fiber of claim 1, having a diameter of less than about 0.5 mm.

11. The endodontic fiber of claim 10, having a diameter of about 0.3 mm.

12. The endodontic fiber of claim 1, wherein the concentration of medicament is about 0.3 mg per 10 mm of fiber.

13. The endodontic fiber of claim 1, wherein said fiber has a rigidity similar to traditional gutta percha points.

14. A method of treating an endodontic bacterial infection using the endodontic fiber of claim 1, the method comprises the steps of:
a) selecting an individual having an endodontic bacterial infection or undergoing endodontic treatment, wherein the individual has one or more root canals; and
b) inserting the endodontic fiber into the one or more root canals;
wherein the endodontic bacterial infection is treated or the root canal is disinfected during treatment.

15. (canceled)

16. The method of claim 14, wherein inflammation in periapical tissue of a tooth undergoing endodontic treatment is reduced.

17. (canceled)

18. An endodontic fiber suitable for the local delivery and sustained release of one or more medicaments incorporated therein to an intracanal treatment site, comprising a biocompatible copolymer vehicle having incorporated therein one or more medicaments, wherein the biocompatible copolymer vehicle comprises one or more polymers selected from the group consisting of starch, lignin, chitin, polysaccharides, chitosan, poly(dioxanone), poly(3-hydroxyvalerate), poly(valerolactone), poly(tartronic acid), poly(β-malonic acid), polypropylene fumarates), polyanhydrides, hydroxybutyric acids, tyrosine-based polycarbonates, polyorthoesters, poly(p-dioxanes), and polyphosphazenes.

19. The endodontic fiber of claim 18, wherein the medicament is selected from the group consisting of antibiotics, anti-inflammatory agents, antimicrobial agents, immune reagents, immunomodulatory agents, reactive oxygen species, and combinations thereof.

20. The endodontic fiber of claim 19, wherein the medicament is an antibiotic selected from the group consisting of clindamycin, tetracycline, and combinations thereof.

21. The endodontic fiber of claim 18, wherein the medicament comprises a combination of an antibiotic and an anti-inflammatory agent.

22. The endodontic fiber of claim 18, wherein the biocompatible copolymer vehicle further comprises one or more non-biodegradable polymers.

23. The endodontic fiber of claim 22, wherein said one or more non-biodegradable polymers is ethylene vinyl acetate.

24. The endodontic fiber of claim 18, wherein the biocompatible copolymer vehicle further comprises less than about 20% ethylene vinyl acetate.

25. The endodontic fiber of claim 24, comprising less than about 15% ethylene vinyl acetate.

26. The endodontic fiber of claim 24, comprising less than about 10% ethylene vinyl acetate.

27. The endodontic fiber of claim 24, comprising about 9.3% ethylene vinyl acetate.

28. The endodontic fiber of claim 18, having a diameter of less than about 0.5 mm.

29. The endodontic fiber of claim 28, having a diameter of about 0.3 mm.

30. The endodontic fiber of claim 18, wherein the medicament is clindamycin, and wherein the clindamycin is incorporated therein at a concentration of about 0.1 mg to about 0.5 mg per 10 mm of fiber.

31. The endodontic fiber of claim 30, wherein the concentration of clindamycin is about 0.3 mg per 10 mm of fiber.

32. The endodontic fiber of claim 18, wherein said fiber has a rigidity similar to traditional gutta percha points.

33. A method of treating an endodontic bacterial infection using the endodontic fiber of claim 18, the method comprises the steps of:
a) selecting an individual having an endodontic bacterial infection or undergoing endodontic treatment, wherein the individual has one or more root canals; and
b) inserting the endodontic fiber into the one or more root canals;
wherein the endodontic bacterial infection is treated or the root canal is disinfected during treatment.

34. (canceled)

35. The method of claim 33, wherein inflammation in periapical tissue of a tooth undergoing endodontic treatment is reduced.

36. (canceled)
